(19) United States
(12) Patent Application Publication
(10) Pub. No.: US 2013/0305517 A1
(43) Pub. Date: Nov. 21, 2013

(54) CAPTURED THREADED CONNECTOR SYSTEM AND METHOD FOR MECHANICALLY COUPLING COMPONENTS

(71) Applicants: Laith Anthony VINCENT, Charlottesville, VA (US); Kenneth Wayne CRAWFORD, Charlottesville, VA (US)

(72) Inventors: Laith Anthony VINCENT, Charlottesville, VA (US); Kenneth Wayne CRAWFORD, Charlottesville, VA (US)

(21) Appl. No.: 13/473,030

(22) Filed: May 16, 2012

(51) Int. Cl. F16B 35/00

(52) U.S. Cl. CPC F16B 35/00
USPC 29/525.11; 411/378

(57) ABSTRACT

Systems and methods for mechanically coupling multiple components using captured threaded connectors are provided. The attachment points between components are aligned along a common central axis about which the channels are aligned. Threaded connectors are provided and contained within a pocket within each component, prior to assembly of the system. As a result, components of the system can be detached without disassembly of other components, or without the use of special thread patterns to allow clearance for the driver for the head of each. Threaded connectors are kept from falling out and are also allowed to float along their axis within the channel so that components can be aligned first, and then anchored together. Drivers used to couple components have a diameter smaller than the channel.

### BACKGROUND OF THE INVENTION

1. Field of the Invention

The field of the invention relates generally to mechanical systems utilizing threaded connectors for coupling components, and more particularly to certain new and useful advances in methods, devices and systems for coupling components using captured threaded connectors, of which the following is a specification.

2. Description of Related Art

Threaded connectors, for e.g., screws, are commonly used to mechanically couple or attach two or more components in a variety of applications. One conventional method for connecting components uses multiple screws with varying thread patterns anchored into threaded channels. In other words, different portions of the channel have to be machined with alternating or varying thread patterns in order to prevent screws from locking together. Another known alternative for coupling components involves screws being placed outside of the components. Specialty screws are another method for coupling multiple components. Typical designs thread one screw of a certain size into the head of another screw of the same size. Yet another conventional method is a single screw of sufficient length that extends through both components being coupled.

These known methods have several disadvantages. For example, although some conventional methods allow screws to connect devices along a single axis, when a single threaded connector is used, multiple screws of varying lengths will have to be employed depending on how many components are being coupled. Moreover, once the components are coupled together, there is no method for removal of one component within the stacked system without uncoupling the other components in the stack. When using conventional methods having multiple connectors along a single channel, currently there are no means for preventing the threaded connectors themselves from binding together. In other words, current systems “permanently” bind components, because if one screw is locked to the other, it is not possible to separate one or more components. In addition, conventional methods do not have a way to prevent the possibility of the screw axis not lining up with the thread axis, which can occur if the components being coupled are slightly tilted), causing cross threading

Thus, systems and methods capable of providing the attachment points of each assembly along the same axis allowing removal of one component, while utilizing the same screw type for repeatability and reduced cost is desired.

### BRIEF SUMMARY OF THE INVENTION

The present disclosure describes embodiments of systems and methods for mechanically coupling components, using captured threaded connectors.

In one embodiment, a method for mechanically connecting a system of at least two components, a first component having a first channel located along a first axis, and a second component having a second channel located along a second axis is provided. The first and second axes may be aligned vertically. They axes may also be aligned horizontally or some combination of the two. In one embodiment, the method comprises the steps of orienting the first component adjacent to the second component so that the first and second axes are aligned; engaging a first connector with a driver, the first connector being captive within a pocket located within the first channel; and coupling the first component to the second component with the first connector using the driver, wherein a diameter of at least a portion of the driver is smaller than a diameter of at least a portion of the first channel. In a further embodiment, the first connector is a threaded connector having a head and a shaft. In another embodiment, only the head is held captive within the pocket. In yet another embodiment, the step of coupling the first component to the second component includes anchoring the first connector into female threads located within the second channel. In an additional embodiment, the system being assembled is electrical in nature, wherein at least one of the first and second components is a compute box. In a preferred embodiment, the diameter or width of the pocket is greater than or equal to a diameter of at least the first channel.

The present invention also provides a system having at least two mechanically coupled components. In one embodiment, the system comprises a first component having a first channel positioned along a first axis; a second component having a second channel aligned along the first axis; and a threaded connector having a head and a shaft, the head being captive within a pocket located within the first channel, wherein the shaft of the threaded connector is anchored into corresponding female threads located within the second channel. In a further embodiment, the first axis is a vertical axis. In another embodiment, the system is electrical in nature, and at least one of the first and second components is a compute box. In yet another embodiment, a diameter of the pocket is greater than or equal to a diameter of the first channel.

One of the benefits and advantages of the subject invention is that a user is able to easily disconnect the last component coupled to the system without decoupling the entire system of components. Another benefit of the subject invention is that the same type and size of threaded connectors, corresponding drivers, and channel thread patterns can be used to couple together components an infinite number of times. Yet another benefit of the present invention is that the threaded connectors are provided and held captive within a pocket within the channel of each of the components during initial assembly which ensures that they are not lost. In addition, providing the threaded connectors within the channel, prior to coupling, assists the user with proper alignment of the channels of each component about the center of the common axes as they are coupled together. Because the screws are able to float within a pocket, the channels of the components are able to be aligned such that the screw axis and the thread axis are the same, which eliminates the possibility of cross threading.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which;

FIG. 1 is a flow chart of a method of mechanically coupling a system of components according to an embodiment of the present invention

FIG. 2 is a perspective view of a system of four components of varying sizes and dimensions coupled together along four common axes according to one exemplary embodiment of the subject invention;

FIG. 3 is a perspective view of an electrical system of four mechanically coupled components, the system includes two compute boxes, a display and a mounting plate according to one embodiment of the subject invention;

FIG. 4 is an exploded perspective view of FIG. 3, illustrating the shared axes about which the corresponding channels of the components are centered and aligned at each selected attachment point;

FIG. 5A is a cross-sectional view of a driver entering the channel of the first component prior to engaging the threaded connector, the diameter of a portion of the driver being smaller than the channel;

FIG. 5B is an enlarged portion of FIG. 5A after the driver has engaged the threaded connector within the pocket; and

FIG. 6 is a cross-sectional view of two components coupled together using an embodiment of the method of the present invention.

Like reference characters designate identical or corresponding components and units throughout the several views, which are not to scale unless otherwise indicated.

### DETAILED DESCRIPTION OF THE INVENTION

The methods and systems of the subject invention provide mechanical coupling of two or more components using one or more threaded connectors. The components are designed with one more internal columns or channels that house threaded connectors at selected attachment points between the devices. The channels are typically located around the perimeter or outer edge of the components in order to avoid any electrical or other elements within the component. Prior to coupling, threaded connectors are provided within a pocket located within one or more of the channels, such that they are held captive within the pocket and unable to fall out should the components by tilted or inverted. The threaded connectors are able to float and move within the pocket, but remain centered about a central axis within the pocket. Components are coupled by anchoring the shaft of the threaded connector of one component into corresponding female threads within the column of a second component.

The present invention employs drivers to access and engage threaded connectors in order to anchor the threaded connectors between components within a system. The force applied to the driver o anchor the threaded connector may be manual or electric. At least a portion of the driver must have a diameter that is smaller than the channel, because the threaded connectors are pre-positioned within the channel. The pre-positioning of the threaded connectors has the benefit and advantage of preventing angular misalignment of the components as they are being coupled together. The coupling process can be repeated as desired in order to secure additional components to the system, or to utilize additional attachment points between the same components, as desired.

As noted above, the methods and systems of the present invention prevent threaded connectors, for e.g. screws, from falling out of the components and becoming lost by using a pocket embedded within the channel of each component. As a result of the captured threaded connector design, multiple components of various types can be coupled, and decoupling of the “topmost” or last coupled component is permitted without decoupling/disassembly of other components within the system. This is particularly beneficial for systems that include components that are utilized for electrical device applications, such as systems that include compute boxes, displays, adaptor plates, etc.

In addition, putting the screws along the same axis and having them thread into the next successive component, but without allowing them to thread into each other, stops the screws from reaching the screws of the secondary or receiving device. This would otherwise cause the screws to become locked, creating one long screw. Moreover, the pocket prevents a screw from being screwed all the way through a device thus not connecting them at all. Yet another advantage of the present invention is the ability to put the attachment points of each assembly along the same axis. This removes the need to create alternating, or multiple assembly configurations to offset successive thread patterns.

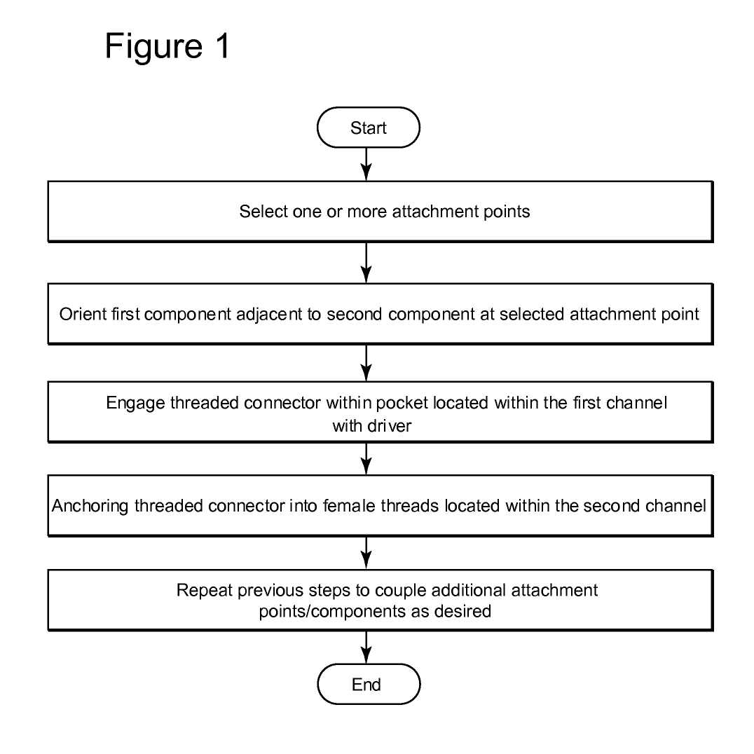

FIG. 1 is a flow chart of a basic method of coupling components according to an exemplary embodiment of the present invention. Prior to the start of system assembly, threaded connectors are provided within a cavity or pocket located within a portion of the channel of one or more components to be coupled. At the stall of assembly, one or more channels are selected to serve as the location of at least one attachment point between two components in the system. Then, the first component is oriented adjacent to the second component at the selected attachment point. Components are typically oriented vertically adjacent to one another about a perpendicular axis. However, adjacent orientation along a horizontal axis, or other mixed arrangements, is also within the scope of the present invention. Next, a driver is used to engage the threaded connector captured within a pocket within the channel of the first component. Once the threaded connector is engaged by the driver, force is applied using the driver in order to anchor the threaded connector through the channel of the first component and into corresponding female threads within the second or receiving channel of the second component. These steps are then repeated to couple the first and second components at other selected attachment points, and/or to couple additional components to the system as desired.

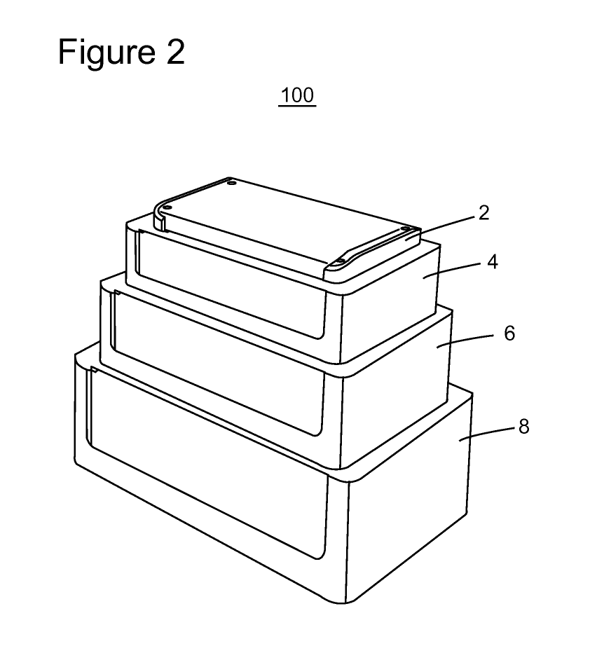

FIG. 2 is a perspective view of an exemplary embodiment of a system 100 of the present invention. System 100 includes four components 2, 4, 6, 8, each having varying dimensions relative to each other. Although the dimensions are different, each component 2, 4, 6 and 8 is capable of being coupled together, in any order, by aligning corresponding channels of the components 2, 4, 6, 8 along one or more common central axes, respectively. In this exemplary embodiment, there are four available channels that can serve as attachment points to secure the components 2, 4, 6, 8 together. When the system is assembled, component 6 is first coupled to component 8, then component 4 is coupled to component 6, and finally component 2 is coupled to component 4. If all four attachments points are used at each stage of assembly, a total of twelve threaded connectors are utilized at the corresponding twelve corresponding attachment points. However, only one attachment point between each component is necessary in order to obtain the benefits and advantages of the present invention. For instance, in one embodiment, a minimum of three threaded connectors are used to connect a system of four components, specifically, at least one threaded connector in between each component in the system.

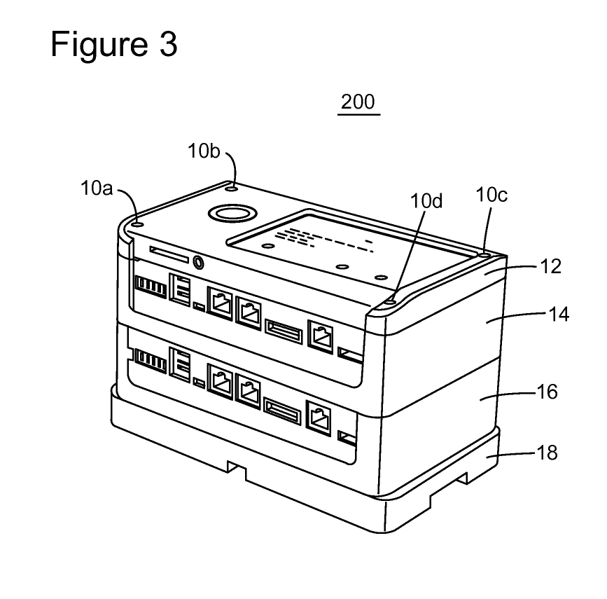

FIG. 3 is a perspective view of an exemplary system 200 according to the present invention. Although systems 100 and 200 in FIGS. 2 and 3, respectively, are illustrated as having vertically coupled components, these embodiments are exemplary and are not intended to limit the methods and systems of the present invention solely to vertically coupled components. Components may be coupled horizontally, vertically or a combination thereof. System 200 includes four electrical components 12, 14, 16, and 18 coupled in a vertically stacked arrangement. In one embodiment, system 200 consists of a display 12, a first compute box 14, a second compute box 16, and a mounting plate 18.

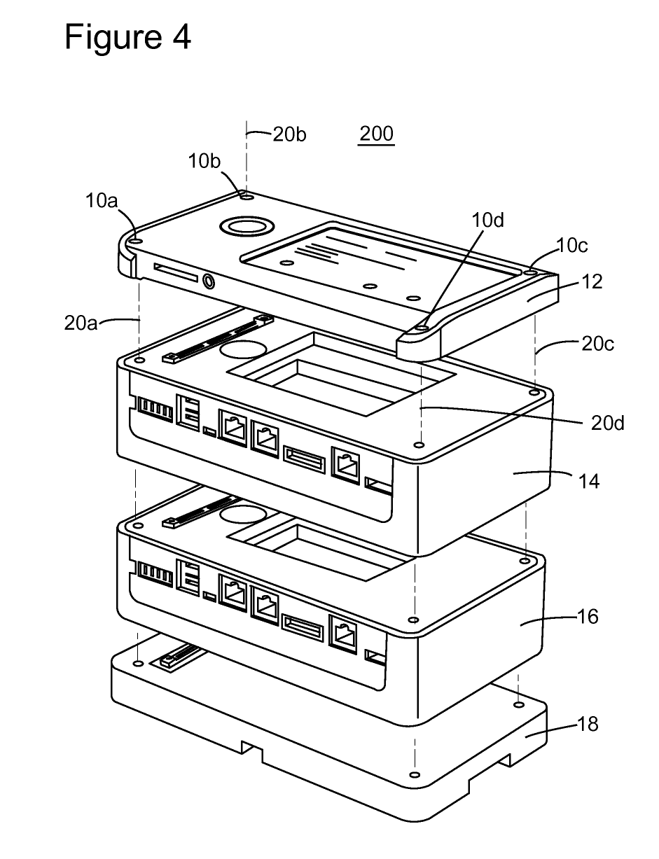

FIG. 4 is an exploded perspective view of FIG. 3, illustrating the shared vertical axes 20a, 20b, 20c, 20d, about which corresponding channels 10a, 10b, 10c, 10d are centered and aligned when components 12, 14, 16, 18 are coupled. As noted above, the subject invention is particularly beneficial for coupling systems in which one or more components need to be detached, or changed in and out, such as the electrical components of system 200. For example, if display 12 needs to be serviced or removed to change a battery, the entire system 200 need not be decoupled. Rather, display 12 can be decoupled from compute box 14 and reattached, without decoupling the remaining components in the system 200. In other words, compute boxes 14 and 16 and mounting plate 18 can remain coupled, even if the display 12 needs to be removed. Moreover, additional components may be added to the top of the system 200, if expansion is desired, without decoupling components 14, 16 and 18.

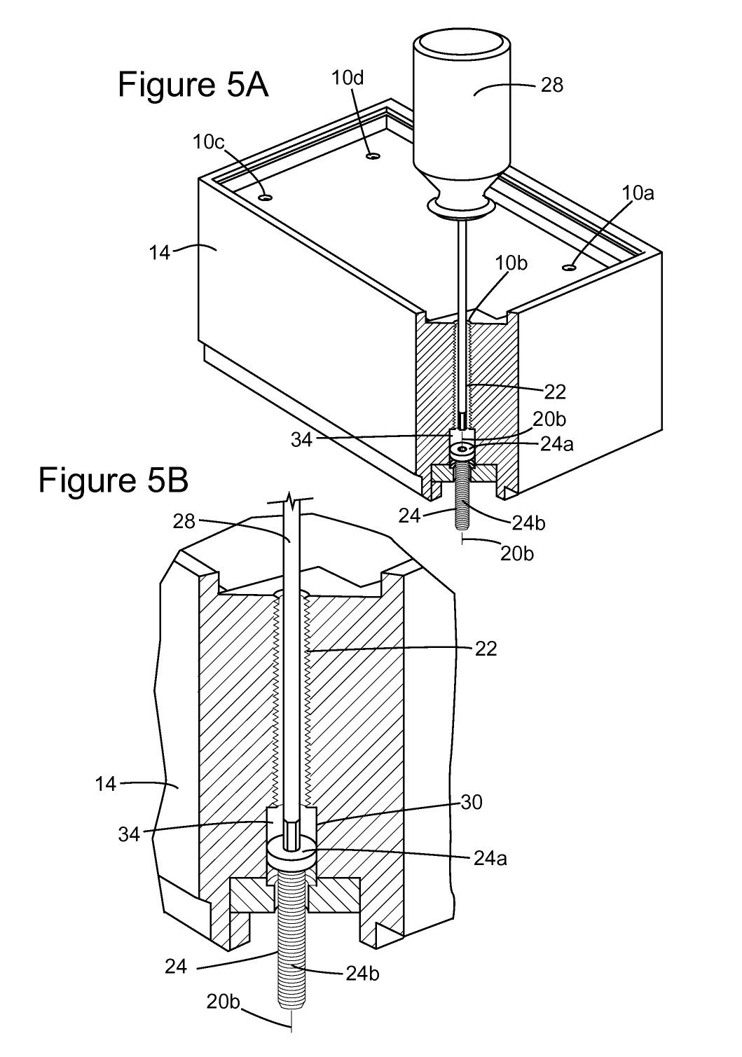

After aligning two components of a system of the present invention, a driver is used to couple them. FIG. 5A is a cross-sectional view of driver 28 entering channel 10b in order to couple component 14 together with component 16 (not shown). Positioned within the channel 10b of component 14 is pocket 30 and threaded connector 24. The threaded connector 24 has a head 24a and a shaft 24b. Prior to assembly, pocket 30 captures at least the head 24a, keeping it from falling out of the channel 10. Because threaded connector 24 is able to hide within the floating space 34 within the clearance pocket 30, the threaded connector 24 is prevented from entering into the second component 16 until the components 14 and 16 are coupled. As illustrated in FIG. 5A, the driver 28 enters the channel 10b and travels past female threads 22 within the channel 10b of the first component 14 on its way to engage threaded connector 24. Notably, a portion of the diameter of the driver 28 is smaller than the diameter or width of the channel 10b in order for the driver 28 to reach the threaded connector 24 captured within.

The channel 10b having female threads 22 within each component acts as a passageway to get the driver 24 to the head 24a of the threaded connector 24 within, and also acts as the actual anchoring mechanism by which the components are mechanically attached. This is possible because the threaded connectors used in the present invention are all captured along shared axes within a given channel, and the driver for the head of each of the threaded connectors has an outer diameter smaller than the channel or female threaded shaft the driver passes through. The present invention thereby eliminates the need for special thread patterns utilized by conventional methods, which would otherwise be required to allow clearance for the driver for the head of each threaded connector.

FIG. 5B is an enlarged view of a portion of FIG. 5A, after the driver 28 has passed through the pocket 30 and engaged the head 24a of threaded connector 24. Pocket 30 has a large enough diameter to allow the head 24a to rotate about the axis 20b and a depth that is long enough to allow the entire threaded connector 24 to move vertically along the central axis 20b. The length of the pocket 30 along the central axis 24 is limited by the length of the threaded connector shaft 24b. Pocket 30 is designed so that threaded connector 24 does not completely enter the pocket 30, thereby maintaining the threaded connector 24 on the same axis 20b while allowing the threaded connector 24 to float and actually recess inside the pocket 30, if necessary. Because pocket 30 captures the head 24a of the threaded connector 24 within pocket 30, misalignment of the components is prevented, prior to coupling.

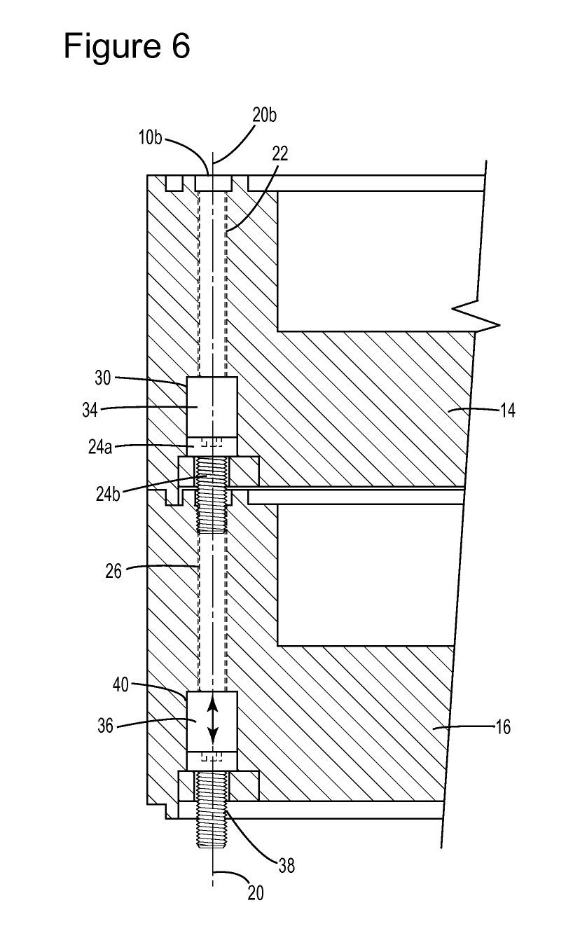

FIG. 6 is a cross-sectional view of two components 14 and 16 coupled together according to one embodiment of the present invention. In this embodiment, only components 14 and 16 are present in the system. Two threaded connectors 24 and 38 are shown. As shown, components 14 and 16 have been aligned at channel 10 about central axis 20b, and then threaded connector 24 is anchored into the female threads 26 of corresponding channel 10b of component 16 at the attachment point. Threaded connector 38 is present within component 16, but is not being utilized to couple another component below component 16. As a result, threaded connector 38 is able to move vertically within the floating space 36 of pocket 40 within component 16 as illustrated by the double headed arrow within the pocket 40. If the bottom surface of component 16 were resting flush against an object beneath it, threaded connector 38 would move vertically upward and recess within pocket 40 and lie flush with the object.

While the figures and description herein generally refer to a threaded connector having a shaft and a head, other threaded connector designs are also envisioned and are within the scope of this invention. In a preferred embodiment, identical threaded connectors are used to couple each of the components at each of the attachment points in the system, providing a significant design, manufacturing and assembly savings in time and cost.

The systems and methods of the present invention are suitable for coupling two or more components together. The components need not have the same dimensions, e.g., perimeter, length, width, thickness, etc. However, at least one of the channels of each of the components must be aligned along a shared axis, typically vertical or horizontal, in order to enable the components to be mechanically coupled according to the subject invention. Components may be electrical in nature, and may also be made of a number of materials or combination of materials, such as wood, metal, plastic, etc.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the scope of the following claims.

What is claimed is:

1. A method for mechanically connecting a system of at least two components, a first component having a first channel located along a first axis, and a second component having a second channel located along a second axis, the method comprising the steps of:
orienting the first component adjacent to the second component so that the first and second axes are aligned;
engaging a first connector with a driver, the first connector being captive within a pocket located within the first channel; and
coupling the first component to the second component with the first connector using the driver, wherein a diameter of at least a portion of the driver is smaller than a diameter of at least a portion of the first channel.

2. The method of claim 1, wherein the first connector is a threaded connector having a head and a shaft.

3. The method of claim 2, wherein only the head is held captive within the pocket.

4. The method of claim 1, wherein the step of coupling the first component to the second component includes anchoring the first connector into female threads located within the second channel.

5. The method of claim 1, wherein the first and second axes are aligned vertically.

6. The method claim 1, wherein at least one of the first and second components is a compute box.

7. The method of claim 1, wherein a diameter of the pocket is greater than or equal to a diameter of the first channel.

8. A system having at Least two mechanically coupled components comprising:
a first component having a first channel positioned along a first axis;
a second component having a second channel aligned along the first axis; and
a threaded connector having a head and a shaft, the head being captive within a pocket located within the first channel;
wherein the shaft of the threaded connector is anchored into corresponding female threads located within the second channel.

9. The system of claim 8, wherein the first axis is a vertical axis.

10. The system of claim 8, wherein at least one of the first and second components is a compute box.

11. The system of claim 8, wherein a diameter of the pocket is greater than or equal to a diameter of the first channel.
